(19) United States
(12) Patent Application Publication
(10) Pub. No.: US 2024/0287331 A1
(43) Pub. Date: Aug. 29, 2024

(54) Ink Jet Ink Composition, Method For Manufacturing Carbide, And Recording Method

(71) Applicant: SEIKO EPSON CORPORATION, Tokyo (JP)

(72) Inventors: Kenta KIKUCHI, Suwa (JP); Hiroaki KUMETA, Nagano (JP); Tetsuya AOYAMA, Shiojiri (JP)

(21) Appl. No.: 18/587,037

(22) Filed: Feb. 26, 2024

(30) Foreign Application Priority Data
Feb. 27, 2023 (JP) 2023-028829

(51) Int. Cl. C09D 11/322; C09B 61/00; C09B 67/54; C09D 11/033; C09D 11/037; C09D 11/14

(52) U.S. Cl. CPC C09D 11/322; C09B 61/00; C09B 67/0096; C09D 11/033; C09D 11/037; C09D 11/14

(57) ABSTRACT

An aqueous ink jet ink composition includes a natural-derived carbide, a dispersant, and a water-soluble organic solvent, the carbide is a carbide obtained by performing a complex separation treatment and an acid dissolution treatment on an untreated carbide, the complex separation treatment is a treatment to remove a complex obtained by mixing the untreated carbide and a chelating agent, and the acid dissolution treatment is a treatment to remove a water-soluble salt obtained by mixing the untreated carbide and an acid.

The present application is based on, and claims priority from JP Application Serial Number 2023-028829, filed Feb. 27, 2023, the disclosure of which is hereby incorporated by reference herein in its entirety.

### BACKGROUND

### 1. Technical Field

The present disclosure relates to an ink jet ink composition, a method for manufacturing a carbide, and a recording method.

### 2. Related Art

Since being able to record a highly fine image by a relatively simple apparatus, an ink jet recording method has been rapidly developed in various fields. In particular, since environmental issues have been concerned in recent years, development of ink using a natural-derived material has been carried out in consideration of the environmental issues.

For example, JP-A-2022-167623 has disclosed an ink jet ink composition containing water, a vegetable-derived carbonized colorant, and a lignin resin.

As the natural-derived material used for ink, for example, vegetable charcoal, such as bamboo charcoal or wood charcoal, may be mentioned.

When those carbides are used as pigments for ink, foreign substances and ejection defects may be generated in some cases. Hence, from the point described above, there is still some room for improvement.

### SUMMARY

According to an aspect of the present disclosure, there is provided an aqueous ink jet ink composition comprising a natural-derived carbide, a dispersant, and a water-soluble organic solvent. In the ink jet ink composition described above, the carbide is a carbide obtained by performing a complex separation treatment and an acid dissolution treatment on an untreated carbide, the complex separation treatment is a treatment to remove a complex obtained by mixing the untreated carbide and a chelating agent, and the acid dissolution treatment is a treatment to remove a water-soluble salt obtained by mixing the untreated carbide and an acid.

According to another aspect of the present disclosure, there is provided a method for manufacturing a carbide which is used for the ink jet ink composition described above, the method comprising a step of performing a complex separation treatment on an untreated carbide and a step of performing an acid dissolution treatment on the untreated carbide. In the method described above, the complex separation treatment is a treatment to remove a complex obtained by mixing the untreated carbide and a chelating agent, and the acid dissolution treatment is a treatment to remove a water-soluble salt obtained by mixing the untreated carbide and an acid.

According to another aspect of the present disclosure, there is provided a recording method comprising a step of ejecting the ink jet ink composition described above from an ink jet head so as to be adhered to a recording medium.

### BRIEF DESCRIPTION OF THE DRAWINGS

FIG. 1s a view showing one example of a recording apparatus used in a recording method of this embodiment.

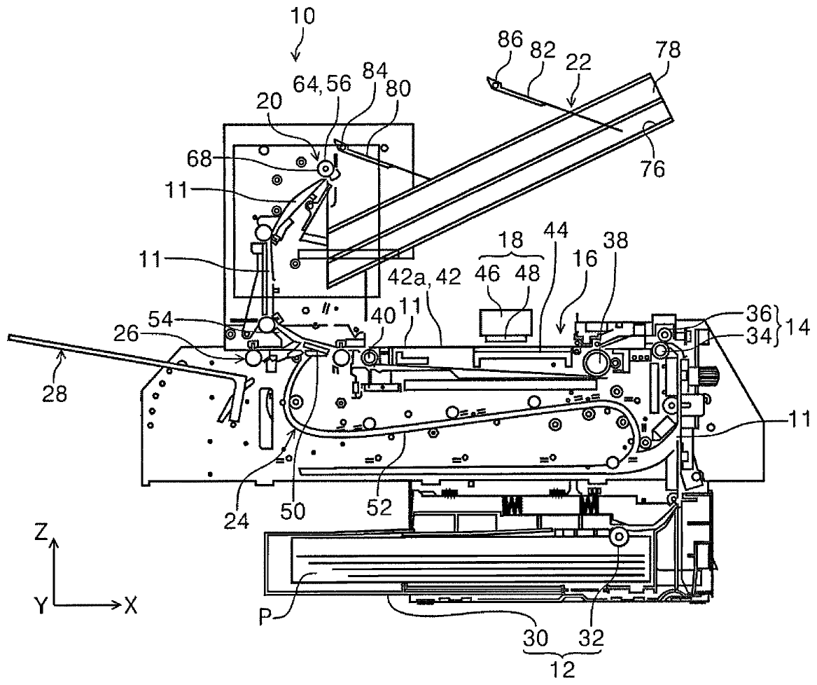

### DESCRIPTION OF EMBODIMENTS

Hereinafter, if needed, with reference to the drawing, although embodiments (hereinafter, each referred to as “this embodiment”) of the present disclosure will be described in detail, the present disclosure is not limited thereto and may be variously modified and/or changed without departing from the scope of the present disclosure. In addition, in the drawing, the same element is designated by the same reference numeral, and duplicated description is omitted. In addition, unless otherwise particularly noted, the top to bottom and the left to right positional relationships are based on the positional relationships shown in the drawing. Furthermore, the dimensional rate shown in the drawing is not limited to that shown therein.

### 1. Ink Jet Ink Composition

An ink jet ink composition (hereinafter, simply referred to as “ink composition” in some cases) according to this embodiment is an aqueous ink jet ink composition and contains a natural-derived carbide, a dispersant, and a water-soluble organic solvent, the carbide is a carbide obtained by performing a complex separation treatment and an acid dissolution treatment on an untreated carbide, the complex separation treatment is a treatment to remove a complex obtained by mixing the untreated carbide and a chelating agent, and the acid dissolution treatment is a treatment to remove a water-soluble salt obtained by mixing the untreated carbide and an acid.

In recent years, in consideration of environmental issues, as a natural-derived colorant used for ink, a black ink using vegetable charcoal, such as bamboo charcoal or wood charcoal, as a pigment has been studied. Heretofore, although a carbon black which is one type of petroleum-derived pigment contains a small amount of metals as impurities, in the case of a vegetable-derived colorant, metals are inevitably contained if a specific treatment is not performed. It has come to understand that when unnecessary metals are mixed in an ink composition, problems occur such that a dispersion stability is degraded to cause generation of foreign substances, and in addition, an ejection stability is degraded to cause generation of nozzle missing or the like.

Since including the structure described above, the ink composition according to this embodiment is able to efficiently remove metal impurities, and hence, a foreign substance resistance and an ejection stability are made excellent.

Hereinafter, components to be contained in the ink composition according to this embodiment, physical properties thereof, and a method for manufacturing the ink composition will be described.

### 1.1. Natural-Derived Carbide

The ink composition contains a natural-derived carbide. The natural-derived carbide may be used as a colorant. The ink composition may also contain a colorant other than the natural-derived carbide.

The natural-derived carbide may be used alone, or at least two types thereof may be used in combination.

A content of the natural-derived carbide is not particularly limited, and for example, the content described above with respect to a total mass of the ink composition is 1.0 to 30 percent by mass. In order to further improve the foreign substance resistance and the ejection stability of the ink composition, the content of the natural-derived carbide with respect to the total mass of the ink composition is preferably 2.0 to 20 percent by mass, more preferably 3.0 to 15 percent by mass, and further preferably 4.0 to 10 percent by mass.

A volume average particle diameter D50 corresponding to a cumulative degree of 50% of the natural-derived carbide is not particularly limited and may be, for example, 0.1 to 1,000 μm. In order to improve the foreign substance resistance and the ejection stability of the ink composition, the volume average particle diameter D50 of the natural-derived carbide is preferably 0.3 to 500 μm, more preferably 0.5 to 100 μm, even more preferably 0.5 to 50 μm, and further preferably 0.5 to 25 μm.

The volume average particle diameter of this embodiment may be measured by a particle size distribution measurement apparatus using a dynamic light scattering method as a measurement principle. Alternatively, the volume average particle diameter of this embodiment may also be measured by a particle size distribution measurement apparatus using a dynamic and electrophoretic light scattering method as a measurement principle. As the particle size distribution measurement apparatus as described above, for example, “ELSZ-2000ZS” (trade name, manufactured by Otsuka Electronics Co., Ltd.) using a homodyne optical system as a frequency analysis method may be mentioned. In addition, in this embodiment, the average particle diameter of the natural-derived carbide may also be measured by measuring the average particle diameter of the ink composition.

### 1.1.1. Vegetable-Derived Carbide

The natural-derived carbide preferably includes a vegetable-derived carbide (in this specification, also called vegetable charcoal in some cases). The vegetable-derived carbide is not particularly limited, and for example, Bincho charcoal, bamboo charcoal, activated charcoal, white charcoal, black charcoal, extruded charcoal, sawdust briquette charcoal, plum charcoal, oak charcoal, Oregon pine charcoal, seaweed charcoal, mangrove charcoal, coconut shell charcoal, or vegetable oil-based carbon black may be used. In addition, in this embodiment, a “natural-derived” compound represents a compound derived from neither petroleum nor coal but from animal or vegetable.

In order to further improve the foreign substance resistance and the ejection stability of the ink composition, as the vegetable-derived carbide, at least one selected from the group consisting of Bincho charcoal, sawdust briquette charcoal, and vegetable oil-based carbon black is preferable.

In this specification, the “natural-derived carbide” may be a carbide which is obtained by carbonizing animal and/or vegetable under a high temperature condition. In addition, the “high temperature condition” is not particularly limited as long as being capable of carbonizing vegetable. For example, there may be used a high-temperature condition at 250° C. or more which is known as “charcoal burner” capable of ashing vegetable, such as bamboo or wood, a high-temperature condition at 350° C. or more at which an un-carbonized component disappears, or a high-temperature condition at 700° C. or more which is realized using a charcoal kiln or the like.

### 1.1.1.1. Element A

The ink composition may contain at least one element A selected from the group consisting of P, S, Si, Cl, Mg, Al, K, Na, Ca, Cr, Ti, Mn, Fe, Ni, and Cu.

The element A may be present in the form of a compound, an ion, or a single element. Among those mentioned above, the element A is preferably present in the form of a water-soluble salt or an ion. In addition, the element A contained in the ink composition may be a carbide-derived element, may be an element derived from another component, or may also be an element added in a step of preparing the ink composition.

A content of the element A with respect to a total mass of the carbide is preferably 1 to 5,000 mass ppm. Since the content of the element A is in the range described above, the foreign substance resistance and the ejection stability of the ink composition are made excellent.

From the same point as described above, the content of the element A with respect to the total mass of the carbide is more preferably 5 to 3,800 mass ppm, even more preferably 10 to 3, 300 mass ppm, further preferably 25 to 1,300 mass ppm, and particularly preferably 50 to 1,000 mass ppm.

A method to measure the mass of the element A in the ink composition is not particularly limited, and for example, an inductively coupled plasma optical emission spectrometry (ICP-OES) or an inductively coupled plasma mass spectrometry (ICP-MS) may be mentioned. In the ink composition of this embodiment, an inductively coupled plasma optical emission spectrometry (ICP-OES) is preferable.

### 1.1.2. Method for Manufacturing Carbide

A method for manufacturing a carbide which is used for the ink jet ink composition according to this embodiment includes a step of performing a complex separation treatment on an untreated carbide and a step of performing an acid dissolution treatment on the untreated carbide, the complex separation treatment is a treatment to remove a complex obtained by mixing the untreated carbide and a chelating agent, and the acid dissolution treatment is a treatment to remove a water-soluble salt obtained by mixing the untreated carbide and an acid.

### 1.1.2.1. Refining of Natural-Derived Carbide

The carbide described above is a carbide (hereinafter, referred to as “treated carbide” in some cases) obtained by performing a complex separation treatment and an acid dissolution treatment on an untreated carbide, the complex separation treatment is a treatment to remove a complex obtained by mixing the untreated carbide and a chelating agent, and the acid dissolution treatment is a treatment to remove a water-soluble salt obtained by mixing the untreated carbide and an acid.

For example, since vegetable contains metal (mineral) components necessary for the growth thereof, various metal components may also be contained in the vegetable-derived carbide. Hence, when the natural-derived carbide contained in the ink composition is refined by the complex separation treatment and the acid dissolution treatment described above, the content of the element A contained in the ink composition can be controlled in a predetermined range.

The natural-derived carbide is preferably a treated carbide obtained by performing the complex separation treatment and the acid dissolution treatment in this order on an untreated carbide.

Although the reason for this has not been identified yet, the acid dissolution treatment is excellent to remove a water-insoluble salt but is liable to aggregate an untreated carbide. When the untreated carbide is aggregated, a water-soluble salt, an ion, and a water-insoluble salt remaining in the aggregate are difficult to be removed. On the other hand, by the complex separation treatment, a water-soluble salt and an ion can be removed without aggregating the untreated carbide. Hence, when the complex separation treatment is performed first to remove a water-soluble salt and an ion, and the acid dissolution treatment is then performed to remove a water-insoluble salt, even if the untreated carbide is aggregated by the acid dissolution treatment, the water-soluble salt, the ion, and the water-insoluble salt can be efficiently removed, and hence, a refining efficiency can be further improved. In addition, as a result, the foreign substance resistance and the ejection stability tend to be further improved.

Hereinafter, the treatments will be described in detail.

### 1.1.2.2. Complex Separation Treatment

The complex separation treatment is a treatment to remove a complex obtained by mixing an untreated carbide and a chelating agent. The untreated carbide may contain an element A in the form of a water-soluble salt, an ion, or a water-insoluble salt. In the complex separation treatment, for example, the chelating agent is allowed to react with a water-soluble salt or an ion to form a complex, and the complex thus formed is separated from the carbide. Accordingly, the water-soluble salt or the ion can be removed from the untreated carbide, and hence, a refined carbide can be obtained.

The mixing between the untreated carbide and the chelating agent may be performed in an aqueous solution. An aqueous solution used for the complex separation treatment is a solution containing water as a primary solvent, and if needed, a water-soluble organic solvent may also be added, or another component, such as a base or an acid, may also added. For example, depending on the type of chelating agent, a base or an acid to adjust the pH may be added to the aqueous solution. In order to suppress an increase in viscosity of the carbide and the aggregation thereof in the complex separation treatment and to improve a separation treatment efficiency of the complex, as one example, the aqueous solution is preferably controlled under basic conditions. In particular, as the aqueous solution, a NaOH aqueous solution may be used.

A mixing temperature between the untreated carbide and the chelating agent is preferably 20° C. to 100° C., more preferably 40° C. to 95° C., and further preferably 60° C. to 95° C. In addition, a mixing time therebetween is preferably 1 to 12 hours, more preferably 2 to 10 hours, and further preferably 3 to 8 hours.

Although a method to remove the complex from a mixture solution of the carbide and the chelating agent is not particularly limited, for example, a known solid-liquid separation method, such as filtration or centrifugal separation, may be used. In the case described above, the carbide processed by the complex separation treatment is separated in the form of a solid, and the complex may be separated in the state of being dissolved in a liquid. In addition, after being separated, the carbide processed by the complex separation treatment may be washed with pure water or the like at least one time. In addition, when a base or an acid is added, in the washing, a neutralization treatment may also be performed.

In the complex separation treatment, the mixing between the untreated carbide and the chelating agent and the removal of the complex thus obtained are regarded as one cycle, and the treatment may be performed at least one cycle.

In addition, when the types of the chemical reagents described above, the mass ratio therebetween, the heating temperature, the heating time, the number of cycles, and the like are adjusted, the amount of the element A in the refined carbide can be appropriately controlled.

As the untreated carbide, a carbide not processed in advance by the complex separation treatment and the acid dissolution treatment may be used without any particular restrictions.

In view of an excellent removal property of a water-soluble salt and an ion, and excellent foreign substance resistance and ejection stability, the volume average particle diameter D50 of the untreated carbide is preferably 0.1 to 1,000 μm, more preferably 0.3 to 500 μm, even more preferably 0.5 to 100 μm, further preferably 0.5 to 50 μm, and particularly preferably 0.5 to 25 μm.

### 1.1.2.2.1. Chelating Agent

The chelating agent is not particularly limited, and for example, there may be mentioned an aminocarboxylic acid-based chelating agent, such as ethylenediaminetetraacetic acid (EDTA), an edetate disalt, nitrilotriacetic acid (NTA), methylglycine diacetic acid (MGDA), diethylenetriaminepentaacetic acid (DTPA), hydroxyethylethylenediaminetriacetic acid (HEDTA), triethylenetetraminehexaacetic acid (TTHA), glutamic acid diacetic acid (GLDA), hydroxyethyliminodiacetic acid (HIDA), dihydroxyethylglycine (DHEG), 1,3-propanediaminetetraacetic acid (PDTA), 1,3-diamino-2-hydroxypropanehexaacetic acid (DPTA-OH), aspartic acid diacetic acid (ASDA), or ethylenediamine succinic acid (EDDS); a phosphonic acid-based chelating agent, such as a pyrophosphate salt, 1-hydroxyethylidene-1,1-diphosphonic acid (HEDP), nitrilotrimethylenephosphonic acid (NTMP), phosphonobutanetricarboxylic acid (PBTC), or ethylenediaminetetramethylenephosphonic acid (EDTMP); a phosphoric acid-based chelating agent, such as a hexametaphosphoric acid salt or tripolyphosphoric acid; or a hydroxycarbonate-based chelating agent, such as citric acid, tartaric acid, or gluconic acid. In addition, the chelating agent may be used alone, or at least two types thereof may be used in combination.

Among those mentioned above, the aminocarboxylic acid-based chelating agent is preferable, and ethylenediaminetetraacetic acid (EDTA) is more preferable. Since the chelating agent as described above is used, the removal property of a water-soluble salt and an ion contained in the untreated carbide, and the foreign substance resistance and the ejection stability tend to be further improved.

A content of the chelating agent is not particularly limited and is, for example, preferably 1.0 to 20.0 parts by mass with respect to 100 parts by mass of the untreated carbide. In order to further improve the removal property of a water-soluble salt and an ion contained in the untreated carbide, and the foreign substance resistance and the ejection stability of the ink composition, the content of the chelating agent with respect to 100 parts by mass of the untreated carbide is more preferably 3.0 to 15.0 parts by mass and further preferably 5.0 to 10.0 parts by mass.

### 1.1.2.3. Acid Dissolution Treatment

The acid dissolution treatment is a treatment to remove a water-soluble salt obtained by mixing an untreated carbide and an acid. The untreated carbide may contain the element A or the like in the form of a water-soluble salt, an ion, or a water-insoluble salt. In the acid dissolution treatment, for example, a water-insoluble salt may be dissolved by the acid to form a water-soluble salt, and the water-soluble salt thus formed is separated from the carbide. Accordingly, the water-insoluble salt can be removed from the untreated carbide, so that a refined carbide can be obtained.

In the acid dissolution treatment, the mixing between the untreated carbide and the acid is preferably performed in an aqueous solution. The aqueous solution used in the acid dissolution treatment is a solution using water as a primary solvent, and if needed, a water-soluble organic solvent may also be added, and/or another component may also be added.

A mixing temperature between the untreated carbide and the acid is preferably 20° C. to 100° C., more preferably 40° C. to 90° C., and further preferably 50° C. to 80° C. In addition, a mixing time therebetween is preferably 1 to 12 hours, more preferably 2 to 10 hours, and further preferably 3 to 8 hours.

Although a method to remove the water-soluble salt from a mixture solution of the carbide and the acid is not particularly limited, for example, a known solid-liquid separation method, such as filtration, centrifugal separation, or filter press, may be used. In the case described above, the carbide processed by the acid dissolution treatment is separated in the form of a solid, and the water-soluble salt may be separated in the state of being dissolved in a liquid. In addition, after being separated, the carbide processed by the acid dissolution treatment may be washed with pure water or the like at least one time. In addition, in the washing, a neutralization treatment may also be performed.

In the acid dissolution treatment, the mixing between the untreated carbide and the acid and the removal of the water-soluble salt thus obtained are regarded as one cycle, and the treatment may be performed at least one cycle.

In addition, when the types of the chemical reagents described above, the mass ratio therebetween, the heating temperature, the heating time, the number of cycles, and the like are adjusted, the amount of the element A in the refined carbide can be appropriately controlled.

### 1.1.2.3.1. Acid

The acid may be used without any particular restrictions. For example, a nitric acid, a sulfuric acid, a silicic acid, a hydrochloric acid, a hypochlorous acid, a hydrogen peroxide, or the like may be mentioned. Among those mentioned above, since the degree of refining is excellent, a nitric acid is preferably used as the acid. When the acid as described above is used, the removal property of a water-insoluble salt contained in the untreated carbide, and the foreign substance resistance and the ejection stability tend to be further improved.

A content of the acid is not particularly limited, and for example, the content described above is preferably 0.01 to 5.0 parts by mass with respect to 100 parts by mass of the untreated carbide. In order to further improve the removal property of a water-insoluble salt contained in the untreated carbide, and the foreign substance resistance and the ejection stability of the ink composition, the content described above with respect to 100 parts by mass of the untreated carbide is more preferably 0.05 to 3.0 parts by mass and further preferably 0.1 to 1.0 parts by mass.

### 1.1.3. Other Colorants

The ink composition may also contain a colorant other than the vegetable-derived carbide. That is, for example, a vegetable-derived colorant other than the vegetable-derived carbide, an animal-derived colorant, and/or a synthetic colorant is also allowed to be contained. As the vegetable-derived colorant other than the vegetable-derived carbide, for example, an anthocyanin-based pigment, a carotenoid-based pigment, a quinone-based pigment, a flavonoid-based pigment, or a betaine-based pigment may be mentioned. In addition, as the animal-derived colorant, for example, squid ink (sepia), cochineal, or Tyrian purple may be mentioned. Furthermore, as the synthetic colorant, for example, isoindolinone, diketopyrrolopyrrole, quinacridone, dioxazine, or phthalocyanine may be mentioned. In consideration of environmental issues, in the ink composition, as the colorant other than the vegetable-derived carbide, a colorant selected from vegetable-derived colorants and animal-derived colorants is preferably contained, and a vegetable-derived colorant is more preferably contained.

In addition, in the ink composition, a content of the colorant other than the vegetable-derived carbide is not particularly limited, and for example, the content described above with respect to the total mass of the ink composition is 0 to 10 percent by mass, preferably 0 to 8.0 percent by mass, more preferably 0.1 to 7.0 percent by mass, and further preferably 0.3 to 5.0 percent by mass.

### 1.2. Dispersant

The ink composition of this embodiment contains a dispersant. The dispersant preferably contains a lignin compound. In addition, as the dispersant, for example, a known high molecular weight dispersant may also be used. Since the ink composition contains a lignin compound, the vegetable-derived carbide is stably dispersed in the ink composition, and hence, the ejection stability of the ink composition is improved thereby. Although the factors thereof have not been clearly understood, a lignin compound and its derivative are likely to trap a polyvalent metal ion to form a complex. Hence, after the metal components and a plurality of lignin compounds in the ink composition are bonded to each other, the lignin compounds and the derivatives thereof stably cover the surface of the vegetable charcoal, and as a result, it is believed that the dispersion stability can be further improved, and a storage stability is also improved. The lignin compound may form a complex with the metal component in the ink composition.

The lignin compound preferably contains a lignosulfonate salt.

The lignosulfonate salt is not particularly limited as long as being a lignin or a lignin decomposed material and having at least one sulfonic group, and the lignosulfonate salt and its derivative are included. The lignosulfonate salt is not particularly limited, and for example, there may be mentioned a ligninsulfonic acid alkali metal salt, such as a sodium, a lithium, or a potassium lignosulfonate, or an ammonium lignosulfonate. In addition, the lignosulfonate salt may be used alone, or at least two types thereof may be used in combination.

A weight average molecular weight of the lignosulfonate salt may be, for example, 1,000 to 80,000. In order to further improve the foreign substance resistance and the ejection stability of the ink composition, the weight average molecular weight of the lignosulfonate salt is preferably 3,000 to 70,000, more preferably 5,000 to 60,000, even more preferably 10,000 to 50,000, further preferably 15,000 to 40,000, and particularly preferably 20,000 to 35,000.

The lignosulfonate salt and its derivative are not particularly limited, and for example, as a commercial product name, for example, there may be mentioned Pearllex NP (manufactured by Nippon Paper Industries Co., Ltd.), Pearllex DP (manufactured by Nippon Paper Industries Co., Ltd.), Vanilex N (manufactured by Nippon Paper Industries Co., Ltd.), 471038-100G (manufactured by Sigma-Aldrich), Newkalgen WG-4 (manufactured by Takemoto Oil & Fat Co., Ltd.), or SAN X P252 (manufactured by Nippon Paper Industries Co., Ltd.). In order to further improve the effect of the ink composition of the present disclosure, as the lignosulfonate salt, Pearllex NP, Vanilex N, Pearllex DP, 471038-100G, Newkalgen WG-4, or SAN X P252 is preferable, and Pearllex NP, Vanilex N, Pearllex DP, 471038-100G, or Newkalgen WG-4 is more preferable.

As the lignosulfonate salt or its derivative, a refined salt having a high purity is preferably used. Since a refined lignosulfonate salt having a high purity is used, chelation of the carbide is promoted, and the foreign substance resistance and the ejection stability of the ink composition can be improved.

A ratio (C/B) of a content (C) of the lignin compound to a content (B) of the carbide is not particularly limited, and for example, the ratio described above may be 0.2 to 4.2. In order to improve the ejection stability of the ink composition, the content ratio (C/B) described above is preferably 0.3 to 3.5, more preferably 0.5 to 3.0, even more preferably 0.7 to 2.5, and further preferably 1.0 to 2.0.

The content of the lignin compound is not particularly limited, and for example, the content described above with respect to the total mass of the ink composition may be 0.1 to 40 percent by mass. In order to more efficiently and reliably obtain the effect of the present disclosure, the content of the lignin compound with respect to the total mass of the ink composition is preferably 0.3 to 35 percent by mass, more preferably 0.5 to 30 percent by mass, even more preferably 1.0 to 25 percent by mass, and further preferably 3.0 to 18 percent by mass.

### 1.3. Water

The ink composition of this embodiment is an aqueous ink composition containing water. The aqueous ink composition is an ink composition at least containing water as a primary solvent component.

A content of the water with respect to the total mass of the ink is preferably 30 to 90 percent by mass, more preferably 40 to 85 percent by mass, and further preferably 50 to 80 percent by mass.

Since the content of the water is not less than the lower value described above, even when the water is partially evaporated, an increase in viscosity of the ink is suppressed, and a sedimentation property tends to be suppressed. In addition, since the content of the water is not higher than the upper value described above, curling tends to be further suppressed.

### 1.4. Water-Soluble Organic Solvent

The ink composition of this embodiment contains a water-soluble organic solvent. Since the ink composition contains a water-soluble organic solvent, the storage stability tends to be further improved. In addition, the water-soluble organic solvent may be used alone, or at least two types thereof may be used in combination.

The water-soluble organic solvent is not particularly limited, and for example, there may be mentioned glycerin, N-methyl pyrrolidone, ethylene glycol, diethylene glycol, triethylene glycol, propylene glycol, dipropylene glycol, tripropylene glycol, propanediol, butanediol, pentanediol, or hexylene glycol. Among those mentioned above, in view of a moisture retaining effect, glycerin is preferable. In addition, the water-soluble organic solvent may be used alone, or at least two types thereof may be used in combination.

A content of the water-soluble organic solvent is not particularly limited, and for example, the content described above with respect to the total mass of the ink composition is 1.0 to 50 percent by mass. In order to more efficiently and reliably obtain the effect of the present disclosure, the content of the water-soluble organic solvent is preferably 3.0 to 40 percent by mass, more preferably 5.0 to 30 percent by mass, and further preferably 8.0 to 20 percent by mass.

### 1.5. Surfactant

The ink composition of this embodiment preferably contains a surfactant. The surfactant is not particularly limited, and for example, an acetylene glycol-based surfactant, a fluorine-based surfactant, or a silicone-based surfactant may be mentioned. Among those mentioned above, in view of the storage stability of the ink composition, an acetylene glycol-based surfactant is preferable. In addition, the surfactant may be used alone, or at least two types thereof may be used in combination.

The acetylene glycol-based surfactant is not particularly limited, and for example, at least one selected from the group consisting of 2,4,7,9-tetramethyl-5-decyne-4,7-diol, an alkylene oxide adduct thereof, 2,4-dimethyl-5-decyne-4-ol, and an alkylene oxide adduct thereof is preferable. A commercial product of the acetylene glycol-based surfactant is not particularly limited, and for example, there may be mentioned Olfine 104 Series or E Series such as Olfine E1010 (trade name, manufactured by Air Products and Chemicals Inc.), or Surfynol 61, 104, or 465 (trade name, manufactured by Nisshin Chemical Industry Co., Ltd.). Among those mentioned above, in order to more efficiently and reliably obtain the effect of the present disclosure, as the surfactant, Olfine E1010 is preferably contained.

A content of the surfactant is not particularly limited, and for example, the content described above with respect to the total mass of the ink composition is 0.01 to 5.0 percent by mass. The content of the surfactant with respect to the total mass of the ink composition is preferably 0.05 to 3.0 percent by mass and more preferably 0.1 to 1.0 percent by mass.

### 1.6. Method for Manufacturing Ink Jet Ink Composition

A method for manufacturing the ink jet ink composition of this embodiment is not particularly limited, and a method in which a natural-derived carbide obtained by performing a complex separation treatment and an acid dissolution treatment on an untreated carbide, a dispersant, and a water-soluble organic solvent are mixed together may be mentioned. In addition, as the dispersant, either a refined dispersant or an unrefined dispersant may be used.

### 2. Recording Method

A recording method of this embodiment includes an ejection step of ejecting the ink jet ink composition of this embodiment from an ink jet head so as to be adhered to a recording medium.

An ink jet method according to this embodiment may further include a transport step of transporting a recording medium. In addition, the ejection step and the transport step may be simultaneously or alternately performed.

### 2.1. Ejection Step

In the ejection step, the ink is ejected from the ink jet head and is adhered to the recording medium. In more particular, a pressure generation device provided in the ink jet head is driven, and the ink filled in a pressure generation chamber of the ink jet head is ejected from a nozzle. The ejection method as described above is also called an ink jet method.

As the ink jet head used in the ejection step, a line head to perform recording by a line method and a serial head to perform recording by a serial method may be mentioned.

In the line method using a line head, for example, an ink jet head having a width equal to or larger than a recording width of a recording medium is fixed in a recording apparatus. In addition, the recording medium is transferred in a sub-scanning direction (transport direction of the recording medium), and in conjunction with this transfer, ink droplets are ejected from the ink jet head, so that an image is recorded on the recording medium.

In the serial method using a serial head, for example, an ink jet head is mounted on a carriage which can be transferred in a width direction of a recording medium. In addition, the carriage is transferred in a main scanning direction (width direction of the recording medium), and in conjunction with this transfer, ink droplets are ejected from the ink jet head, so that an image is recorded on the recording medium.

### 2.2. Transport Step

In the transport step, the recording medium is transported in a predetermined direction in the recording apparatus. In more particular, using a transport roller and/or a transport belt provided in the recording apparatus, the recording medium is transported from a paper supply portion to a paper discharge portion in the recording apparatus. In this transport step, the ink ejected from the ink jet head is adhered to the recording medium, so that a recorded matter is formed. The transport may be performed continuously or intermittently.

### 2.3. Recording Medium

A recording medium used in this embodiment is not particularly limited, and for example, an absorbing or a non-absorbing recording medium may be mentioned.

The absorbing recording medium is not particularly limited, and for example, there may be mentioned media from regular paper, such as electrophotographic paper, having a high ink permeability and ink jet paper (ink jet exclusive paper including an ink absorbing layer formed from silica particles or alumina particles or an ink absorbing layer formed of a hydrophilic polymer, such as a poly(vinyl alcohol) (PVA) or a poly(vinyl pyrrolidone) (PVP)) to art paper, coated paper, and cast paper each of which has a relatively low ink permeability and is used for general offset printing.

Although the non-absorbing recording medium is not particularly limited, for example, there may be mentioned a film or a plate formed from a plastic, such as a poly(vinyl chloride), a polyethylene, a polypropylene, a poly(ethylene terephthalate) (PET), a polycarbonate, a polystyrene, or a polyurethane; a plate formed from a metal, such as iron, silver, copper, or aluminum; a metal plate or a plastic-made film manufactured by deposition of at least one of the various metals mentioned above; a plate formed from an alloy, such as stainless steel or brass; or a recording medium in which a film of a plastic, such as a poly(vinyl chloride), a polyethylene, a polypropylene, a poly(ethylene terephthalate) (PET), a polycarbonate, a polystyrene, or a polyurethane, is adhered (coated) to a paper-made substrate.

### 3. Recording Apparatus

A recording apparatus of this embodiment includes an ink jet head having at least one nozzle to eject an ink jet ink composition to a recording medium and a transport device to transport the recording medium. The ink jet head includes a pressure chamber to which the ink is supplied and the nozzle to eject the ink. In addition, the transport device is formed from a transport roller and/or a transport belt provided in the recording apparatus.

Hereinafter, the recording apparatus according to this embodiment will be described with reference to FIGURE. In addition, in the X-Y-Z coordinate system shown in FIGURE, an X direction indicates a length direction of the recording medium, a Y direction indicates a width direction of the recording medium in a transport path in the recording apparatus, and a Z direction indicates a height direction of the apparatus.

As one example of a recording apparatus 10, a line type ink jet printer capable of performing printing at a high speed and at a high density will be described. The recording apparatus 10 includes a feed portion 12 to store a recording medium P such as paper, a transport portion 14, a belt transport portion 16, a record portion 18, an Fd (facedown) discharge portion 20 functioning as a “discharge portion”, an Fd (facedown) stage 22 functioning as a “stage”, a reverse path portion 24 functioning as a “reverse transport mechanism”, an Fu (faceup) discharge portion 26, and an Fu (faceup) stage 28.

The feed portion 12 is disposed at a lower side of the recording apparatus 10. The feed portion 12 includes a feed tray 30 to store the recording medium P and a feed roller 32 to feed the recording medium P stored in the feed tray 30 to a transport path 11.

The recording medium P stored in the feed tray 30 is fed to the transport portion 14 along the transport path 11 by the feed roller 32. The transport portion 14 includes a transport drive roller 34 and a transport driven roller 36. The transport drive roller 34 is rotationally driven by a driving source not shown. In the transport portion 14, the recording medium P is nipped between the transport drive roller 34 and the transport driven roller 36 and is then transported to the belt transport portion 16 located downstream of the transport path 11.

The belt transport portion 16 includes a first roller 38 located upstream of the transport path 11, a second roller 40 located downstream thereof, an endless belt 42 fitted to the first roller 38 and the second roller 40 in a rotationally transferable manner, and a support body 44 to support an upper-side section 42a of the endless belt 42 between the first roller 38 and the second roller 40.

The endless belt 42 is driven by the first roller 38 or the second roller 40 driven by a driving source not shown so as to be transferred from a +X direction to a −X direction in the upper-side section 42a. Hence, the recording medium P transported from the transport portion 14 is further transported downstream of the transport path 11 in the belt transport portion 16.

The record portion 18 includes a line type ink jet head 48 and a head holder 46 to hold the ink jet head 48. In addition, the record portion 18 may also be a serial type in which an ink jet head is mounted on a carriage which is reciprocally transferred in a Y axis direction. The ink jet head 48 is disposed so as to face the upper-side section 42a of the endless belt 42 supported by the support body 44. When the recording medium P is transported in the upper-side section 42a of the endless belt 42, the ink jet head 48 ejects the ink to the recording medium P, so that the recording is carried out. While the recording is carried out, the recording medium P is transported downstream of the transport path 11 by the belt transport portion 16.

In addition, the “line type ink jet head” is a head used for the recording apparatus in which a nozzle region formed in a direction intersecting the transport direction of the recording medium P is provided so as to cover the entire recording medium P in the intersecting direction, and while one of the head and the recording medium P is fixed, the other is transferred to form an image. In addition, the nozzle region of the line head in the intersecting direction may not be always required to cover the entire region in the intersecting direction of every type of recording medium P that can be applied to the recording apparatus.

In addition, a first branch portion 50 is provided downstream of the transport path 11 of the belt transport portion 16. The first branch portion 50 is configured to switchably communicate with one of the transport path 11 to transport the recording medium P to the Fd discharge portion 20 or the Fu discharge portion 26 and a reverse path 52 of the reverse path portion 24 in which after a recording surface of the recording medium P is reversed, the recording medium P is again transported to the record portion 18. In addition, the recording medium P to be transported after the transport path 11 is switched to the reverse path 52 by the first branch portion 50 is processed such that the recording surface thereof is reversed in a transport process in the reverse path 52 and is again transported to the record portion 18 so that a surface of the recording medium P opposite to the original recording surface faces the ink jet head 48.

In addition, a second branch portion 54 is further provided downstream of the first branch portion 50 along the transport path 11. The second branch portion 54 is configured so as to transport the recording medium P to one of the Fd discharge portion 20 and the Fu discharge portion 26 by switching the transport direction of the recording medium P.

The recording medium P transported to the Fd discharge portion 20 by the second branch portion 54 is discharged from the Fd discharge portion 20 and then placed on the Fd stage 22. In this case, the recording surface of the recording medium P is placed so as to face the Fd stage 22. In addition, the recording medium P transported to the Fu discharge portion 26 by the second branch portion 54 is discharged from the Fu discharge portion 26 and then placed on the Fu stage 28. In this case, the recording surface of the recording medium P is placed so as to face a side opposite to the Fu stage 28.

In addition, although the case in which the line type ink jet head is used has been described above by way of example, the recording apparatus of this embodiment may be a printer (serial printer) using a serial type ink jet head. In the serial printer, while a recording medium is transported in a transport direction, the ink jet head is transferred in a direction intersecting the transport direction described above, so that the printing is performed.

### 4. Recorded Matter

A recorded matter of this embodiment is obtained by adhering the ink composition to a recording medium. Since the ink composition described above is excellent in ejection stability, even when repetitive recording is performed, recorded matters can be stably obtained.

### EXAMPLES

Hereinafter, the present disclosure will be described in more detail with reference to Examples and Comparative Examples. The present disclosure is not at all limited to the following Examples.

### 1. Preparation of Treated Carbide

In Tables 1 to 3, the type of untreated carbide, the types and order of treatments performed on the untreated carbide, treatment agents used in each treatment, and the composition of the element A contained in a treated carbide are shown. In addition, in Tables 1 to 3, “-” shown in the column of the treatment indicates that the treatment is not performed. In addition, in Tables 1 to 3, in the column of the treatment, A represents a complex separation treatment, and B represents an acid dissolution treatment.

### 1.1. Treatment a: Complex Separation Treatment

In the complex separation treatment, as a chelating agent, an EDTA salt (ethylenediaminetetraacetate salt) or HEDP (1-hydroxyethylidene-1,1-diphosphonic acid) was used. First, after an untreated carbide and the chelating agent were mixed together in water and then stirred at 90° C. for 4 hours, a solid-liquid separation was performed by centrifugal separation, so that the carbide was recovered. The operation described above was repeated once, so that a carbide processed by the complex separation treatment was obtained. In addition, in the preparation of carbide 2 shown in Table 1, the operation described above was repeated three times.

In the operation described above, when the EDTA salt (ethylenediaminetetraacetate salt) was used as the chelating agent, sodium hydroxide was added in the water to have a concentration of 0.5 percent by mass.

In the treatment A, after pure water was added to the carbide processed by the complex separation treatment to form a slurry, a NaOH solution (the concentration thereof may be adjusted at the same molar concentration of the acid) was dripped to and mixed with the slurry, and a pH of 8 to 9 was regarded as the end point. Subsequently, the solid-liquid separation was again performed, so that the carbide was recovered.

### 1.2. Treatment B: Acid Dissolution Treatment

In the acid dissolution treatment, a nitric acid or a hydrochloric acid was used. First, after an untreated carbide and the acid were mixed together in water and then stirred at 60° C. for 6 hours, a solid-liquid separation was performed by centrifugal separation, so that the carbide was recovered. This operation was repeated once, so that a carbide processed by the acid dissolution treatment was obtained.

In the treatment B, after pure water was added to the carbide processed by the complex separation treatment to form a slurry, a nitric acid solution (the concentration thereof may be adjusted at the same molar concentration of the alkali) was dripped to and mixed with the slurry, and a pH of 8 to 9 was regarded as the end point. Subsequently, the solid-liquid separation was again performed, so that the carbide was recovered.

### 1.3. High-Temperature Steam Treatment

In carbide 16 shown in Table 3, a refining treatment was performed by a high-temperature steam treatment using a sodium hydroxide without performing the complex separation treatment and the acid dissolution treatment. In particular, the carbide was filled in a flow reactor tube, and the tube was filled with nitrogen. Steam heated to 600° C. was allowed to flow through the tube for 30 minutes. Subsequently, the inside of the reactor tube was cooled to room temperature, and the carbide was then recovered.

### 1.4. Measurement Method

### 1.4.1. Measurement of Particle Diameter D50

An average particle diameter of an untreated carbide was measured using a particle size distribution measurement device (ELSZ-1000, manufactured by Otsuka Electronics Co., Ltd.). A D50 diameter based on a scattering intensity distribution is represented by “D50 particle diameter” in Tables 1 to 3.

### 1.4.2. MASS ANALYSIS OF ELEMENT A

A mass analysis of the element A in a treated carbide was performed using an ICP-OES (G8015AA, manufactured by Agilent Technologies).

In addition, a total content of the element A in the treated carbide obtained by the mass analysis of the element A described above was evaluated in accordance with the following evaluation criteria. The results are shown in Tables 1 to 3.

### Evaluation Criteria

AA: Total content of element A is 0 to less than 100 mass ppm.

A: Total content of element A is 100 to less than 1,000 mass ppm.

B: Total content of element A is 1,000 to less than 3,000 mass ppm.

C: Total content of element A is 3,000 to less than 5,000 mass ppm.

D: Total content of element A is 5,000 mass ppm or more.

TABLE 1

| | | | CARBIDE | | | |
|---|---|---|---|---|---|---|
| | | | 1 | 2 | 3 | 4 |
| REFINING | TREATMENT (FIRST) | | A | A | B | A |
| TREATMENT | TREATMENT (SECOND) | | B | B | A | B |
| UNTREATED CARBIDE | BINCHO CHARCOAL (VEGETABLE | PARTS BY MASS | 100 | 100 | 100 | 100 |
| | CHARCOAL) | | | | | |
| | SAWDUST BRIQUETTE CHARCOAL | PARTS BY MASS | — | — | — | — |
| | (VEGETABLE CHARCOAL) | | | | | |
| | VEGETABLE OIL-BASED CARBON | PARTS BY MASS | — | — | — | — |
| | BLACK | | | | | |
| | GRANULAR BINCHO CHARCOAL | PARTS BY MASS | — | — | — | — |
| | (VEGETABLE CHARCOAL) | | | | | |
| COLORANT OTHER | PB-15:1 (PHTHALOCYANINE) | PARTS BY MASS | — | — | — | — |
| THAN CARBIDE | | | | | | |
| VOLUME AVERAGE PARTICLE DIAMETER | | μm | 0.5 | 0.5 | 0.5 | 100 |
| OF UNTREATED CARBIDE (D50) | | | | | | |
| A TREATMENT/ | EDTA (AMINOCARBOXYLIC ACID | PARTS BY MASS | 5 | 5 | 5 | 5 |
| CHELATING AGENT | TYPE) | | | | | |
| | HEDP (PHOSPHONIC ACID TYPE) | PARTS BY MASS | — | — | — | — |
| B TREATMENT/ACID | NITRIC ACID | PARTS BY MASS | 0.1 | 1.0 | 1.0 | 0.1 |
| | HYDROCHLORIC ACID | PARTS BY MASS | — | — | — | — |
| HIGH-TEMPERATURE | SODIUM HYDROXIDE (1.0M) | PARTS BY MASS | — | — | — | — |
| STEAM | | | | | | |
| TREATMENT/ADDITIVE | | | | | | |
| ELEMENT A | TOTAL CONTENT | MASS ppm | 400 | 80 | 1400 | 1250 |
| CONTAINED IN | SLIGHTLY SOLUBLE-SALT | MASS ppm | 20 | 5 | 990 | 50 |
| TREATED CARBIDE | COUNTER ION: P | | | | | |
| | SOLUBLE-SALT COUNTER ION: S | MASS ppm | 7 | 5 | 5 | 50 |
| | SOLUBLE-SALT COUNTER ION: Si | MASS ppm | 7 | 5 | 5 | 50 |
| | SOLUBLE-SALT COUNTER ION: Cl | MASS ppm | 7 | 5 | 5 | 50 |
| | Mg | MASS ppm | 50 | 15 | 100 | 150 |
| | Al | MASS ppm | 10 | 0 | 20 | 20 |
| | K | MASS ppm | 40 | 10 | 10 | 150 |
| | Na | MASS ppm | 50 | 10 | 10 | 150 |
| | Ca | MASS ppm | 150 | 15 | 200 | 400 |
| | Cr | MASS ppm | 10 | 0 | 10 | 80 |
| | Ti | MASS ppm | 10 | 0 | 10 | 20 |
| | Mn | MASS ppm | 10 | 5 | 5 | 20 |
| | Fe | MASS ppm | 10 | 5 | 20 | 20 |
| | Ni | MASS ppm | 10 | 0 | 5 | 20 |
| | Cu | MASS ppm | 9 | 0 | 5 | 20 |
| | EVALUATION | MASS ppm | A | AA | B | B |

TABLE 2

| | | | CARBIDE | | | | |
|---|---|---|---|---|---|---|---|
| | | | 7 | 8 | 9 | 10 | 11 |
| REFINING | TREATMENT (FIRST) | | A | A | A | A | A |
| TREATMENT | TREATMENT (SECOND) | | B | B | B | B | B |
| UNTREATED CARBIDE | BINCHO CHARCOAL (VEGETABLE | PARTS BY MASS | — | — | — | 100 | 100 |
| | CHARCOAL) | | | | | | |
| | SAWDUST BRIQUETTE CHARCOAL | PARTS BY MASS | 100 | — | — | — | — |
| | (VEGETABLE CHARCOAL) | | | | | | |
| | VEGETABLE OIL-BASED CARBON | PARTS BY MASS | — | 100 | — | — | — |
| | BLACK | | | | | | |
| | GRANULAR BINCHO CHARCOAL | PARTS BY MASS | — | — | 100 | — | — |
| | (VEGETABLE CHARCOAL) | | | | | | |
| COLORANT OTHER | PB-15:1 (PHTHALOCYANINE) | PARTS BY MASS | — | — | — | — | — |
| THAN CARBIDE | | | | | | | |
| VOLUME AVERAGE PARTICLE DIAMETER | | μm | 1.0 | 10 | 1000 | 10 | 10 |
| OF UNTREATED CARBIDE (D50) | | | | | | | |
| A TREATMENT/ | EDTA (AMINOCARBOXYLIC ACID | PARTS BY MASS | 7.5 | 5 | 10 | — | 5 |
| CHELATING AGENT | TYPE) | | | | | | |
| | HEDP (PHOSPHONIC ACID TYPE) | PARTS BY MASS | — | — | — | 5 | — |
| B TREATMENT/ACID | NITRIC ACID | PARTS BY MASS | 1.0 | 0.1 | 1.0 | 0.1 | — |
| | HYDROCHLORIC ACID | PARTS BY MASS | — | — | — | — | 0.1 |
| HIGH-TEMPERATURE | SODIUM HYDROXIDE (1.0M) | PARTS BY MASS | — | — | — | — | — |
| STEAM | | | | | | | |
| TREATMENT/ADDITIVE | | | | | | | |
| ELEMENT A | TOTAL CONTENT | MASS ppm | 150 | 10 | 4000 | 1450 | 3400 |
| CONTAINED IN | SLIGHTLY SOLUBLE-SALT | MASS ppm | 10 | 0.5 | 200 | 100 | 100 |
| TREATED CARBIDE | COUNTER ION: P | | | | | | |
| | SOLUBLE-SALT COUNTER ION: S | MASS ppm | 10 | 0.5 | 200 | 100 | 100 |
| | SOLUBLE-SALT COUNTER ION: Si | MASS ppm | 10 | 0.5 | 200 | 100 | 100 |
| | SOLUBLE-SALT COUNTER ION: Cl | MASS ppm | 10 | 0.5 | 200 | 100 | 1000 |
| | Mg | MASS ppm | 20 | 2 | 750 | 300 | 150 |
| | Al | MASS ppm | 20 | 0 | 50 | 20 | 50 |
| | K | MASS ppm | 10 | 1 | 250 | 50 | 200 |
| | Na | MASS ppm | 20 | 1 | 500 | 200 | 1000 |
| | Ca | MASS ppm | 20 | 3 | 1200 | 400 | 500 |
| | Cr | MASS ppm | 0 | 0 | 100 | 100 | 50 |
| | Ti | MASS ppm | 0 | 0 | 50 | 20 | 50 |
| | Mn | MASS ppm | 5 | 0 | 50 | 20 | 100 |
| | Fe | MASS ppm | 5 | 1 | 150 | 100 | 100 |
| | Ni | MASS ppm | 5 | 0 | 50 | 20 | 50 |
| | Cu | MASS ppm | 5 | 0 | 50 | 20 | 50 |
| | EVALUATION | MASS ppm | A | AA | C | B | C |

TABLE 3

| | | | CARBIDE | | | | |
|---|---|---|---|---|---|---|---|
| | | | 12 | 13 | 14 | 15 | 16 |
| REFINING | TREATMENT (FIRST) | | — | A | — | A | — |
| TREATMENT | TREATMENT (SECOND) | | — | — | B | B | — |
| UNTREATED CARBIDE | BINCHO CHARCOAL (VEGETABLE | PARTS BY MASS | 100 | 100 | 100 | — | 100 |
| | CHARCOAL) | | | | | | |
| | SAWDUST BRIQUETTE CHARCOAL | PARTS BY MASS | — | — | — | — | — |
| | (VEGETABLE CHARCOAL) | | | | | | |
| | VEGETABLE OIL-BASED CARBON | PARTS BY MASS | — | — | — | — | — |
| | BLACK | | | | | | |
| | GRANULAR BINCHO CHARCOAL | PARTS BY MASS | — | — | — | — | — |
| | (VEGETABLE CHARCOAL) | | | | | | |
| COLORANT OTHER | PB-15:1 (PHTHALOCYANINE) | PARTS BY MASS | — | — | — | 100 | — |
| THAN CARBIDE | | | | | | | |
| VOLUME AVERAGE PARTICLE DIAMETER | | μm | 0.5 | 0.5 | 0.5 | — | — |
| OF UNTREATED CARBIDE (D50) | | | | | | | |
| A TREATMENT/ | EDTA (AMINOCARBOXYLIC ACID | PARTS BY MASS | — | 5 | — | 5 | — |
| CHELATING AGENT | TYPE) | | | | | | |
| | HEDP (PHOSPHONIC ACID TYPE) | PARTS BY MASS | — | — | — | — | — |
| B TREATMENT/ACID | NITRIC ACID | PARTS BY MASS | — | — | 1.0 | 1.0 | — |
| | HYDROCHLORIC ACID | PARTS BY MASS | — | — | — | — | — |
| HIGH-TEMPERATURE | SODIUM HYDROXIDE (1.0M) | PARTS BY MASS | — | — | — | — | 50 |
| STEAM | | | | | | | |
| TREATMENT/ADDITIVE | | | | | | | |
| ELEMENT A | TOTAL CONTENT | MASS ppm | 20000 | 5300 | 5400 | 15 | 80 |
| CONTAINED IN | SLIGHTLY SOLUBLE-SALT | MASS ppm | 2100 | 2100 | 990 | 1 | 5 |
| TREATED CARBIDE | COUNTER ION: P | | | | | | |
| | SOLUBLE-SALT COUNTER ION: S | MASS ppm | 700 | 10 | 330 | 1 | 5 |
| | SOLUBLE-SALT COUNTER ION: Si | MASS ppm | 700 | 10 | 330 | 1 | 5 |
| | SOLUBLE-SALT COUNTER ION: Cl | MASS ppm | 700 | 10 | 330 | 1 | 5 |
| | Mg | MASS ppm | 5000 | 500 | 700 | 3 | 15 |
| | Al | MASS ppm | 500 | 50 | 50 | 1 | 0 |
| | K | MASS ppm | 2000 | 300 | 300 | 0 | 10 |
| | Na | MASS ppm | 3500 | 700 | 700 | 1 | 10 |
| | Ca | MASS ppm | 6000 | 800 | 1000 | 5 | 15 |
| | Cr | MASS ppm | 300 | 250 | 250 | 0 | 0 |
| | Ti | MASS ppm | 200 | 120 | 100 | 0 | 0 |
| | Mn | MASS ppm | 200 | 50 | 50 | 0 | 5 |
| | Fe | MASS ppm | 500 | 300 | 200 | 1 | 5 |
| | Ni | MASS ppm | 200 | 50 | 30 | 0 | 0 |
| | Cu | MASS ppm | 200 | 50 | 40 | 0 | 0 |
| | EVALUATION | MASS ppm | D | D | D | AA | AA |

The abbreviations and details of the product components in Tables 1 to 3 are as shown below.

### Carbide (Colorant)

Bincho charcoal (manufactured by Kiriya Chemical Co., Ltd.)
sawdust briquette charcoal (manufactured by Nara Tanka Industries Co., Ltd.)
vegetable oil-based carbon black (manufactured by Orion Engineered Carbons)
granular Bincho charcoal (manufactured by Nara Tanka Industries Co., Ltd.)
   Colorant Other than Carbide
PB-15:1 (phthalocyanine)

### Chelating Agent

EDTA ethylenediaminetetraacetate salt
HEDP 1-hydroxyethylidene-1,1-diphosphoric acid

### Acid

nitric acid
hydrochloric acid

### Steam Activation Alkali Additive

sodium hydroxide (1.0 M)

### 2. Preparation of Ink Composition

In order to have one of the compositions shown in Tables 4 to 6, after components were charged in a mixing tank and then mixed and stirred, filtration was further performed using a membrane filter, so that an ink jet ink composition of each Example was obtained.

In addition, unless otherwise particularly noted, the numerical value of each component of each Example shown in the table is on a percent by mass basis. In addition, in the table, the numerical value of the colorant represents percent by mass of a solid content.

The abbreviations and details of the product components in Tables 4 to 6 are as shown below.

### Dispersant

refined sodium lignosulfonate (commercial product)

### Solvent (Water-Soluble Organic Solvent)

propylene glycol (commercial product)
glycerin (commercial product)

### Surfactant

Olfine E1010 (manufactured by Nisshin Chemical Industry Co., Ltd.)

### 2.1. Mass Analysis of Trace Element (Element A)

A mass analysis of a trace element (element A) in the ink was performed using an ICP-OES (G8015AA, manufactured by Agilent Technologies). A total content of the element A is shown in Tables 4 to 6.

### 3. Evaluation Method

### 3.1. Foreign Substance Resistance

First, 10 mL of the ink was received in a glass bottle and was then left at 60° C. for 5 days in the state in which an air-liquid interface was present. Subsequently, after the ink was filtrated using a metal mesh filter (pore size: 10 μm), the number of solids remaining on the metal mesh filter per square mm was counted and then evaluated in accordance with the following evaluation criteria.

### Evaluation Criteria

AA: number of solids per square mm is less than 5.
A: number of solids per square mm is 5 to less than 20.
B: number of solids per square mm is 20 to less than 30.
C: number of solids per square mm is 30 to less than 50.
D: number of solids per square mm is 50 or more.

### 3.2. Ejection Stability

The ink was filled in an ink container and then left for 5 days in an environment at 60° C. Subsequently, after the container described above was mounted in a recording apparatus (PX-H6000, manufactured by Seiko Epson Corporation), the ink was ejected to regular paper at a horizontal resolution of 1,440 dpi and a vertical resolution of 720 dpi to form a solid pattern at a duty of 100%. In addition, an operation condition of the recording apparatus was set to a temperature of 40° C. and a relative humidity of 20%. After 50 sheets were continuously printed, the number of missing nozzles was counted.

In addition, in this specification, the “duty” is the value calculated by the following equation.

$$Duty ( \% ) = number of actual printed dots / ( vertical resolution \times horizontal resolution ) \times 100$$

In the above equation, the “number of actual printed dots” indicates the number of dots in actual printing, the “vertical resolution” and the “horizontal resolution” each represent a resolution per unit area. In addition, the “duty of 100%” indicates the maximum ink weight of a single color per unit pixel.

### Evaluation Criteria

AA: number of missing nozzles is 0.
A: number of missing nozzles is 1 to 9.
B: number of missing nozzles is 10 to 19.
C: number of missing nozzles is 20 to 29.
D: number of missing nozzles is 30 or more.

TABLE 4

| | | | EXAMPLE | EXAMPLE | EXAMPLE | EXAMPLE | EXAMPLE |
|---|---|---|---|---|---|---|---|
| | | | 1 | 2 | 3 | 4 | 5 |
| INK | | | INK 1 | INK 2 | INK 3 | INK 4 | INK 5 |
| COLORANT | CARBIDE | CARBIDE 1 | 6.0 | — | — | — | — |
| | | CARBIDE 2 | — | 6.0 | — | — | — |
| | | CARBIDE 3 | — | — | 6.0 | — | — |
| | | CARBIDE 4 | — | — | — | 6.0 | — |
| | | CARBIDE 7 | — | — | — | — | 6.0 |
| | | CARBIDE 8 | — | — | — | — | — |
| | | CARBIDE 9 | — | — | — | — | — |
| | | CARBIDE 10 | — | — | — | — | — |
| | | CARBIDE 11 | — | — | — | — | — |
| | | CARBIDE 12 | — | — | — | — | — |
| | | CARBIDE 13 | — | — | — | — | — |
| | | CARBIDE 14 | — | — | — | — | — |
| | COLORANT | COLORANT 15 | — | — | — | — | — |
| | OTHER | | | | | | |
| | THAN | | | | | | |
| | CARBIDE | | | | | | |
| | STEAM | CARBIDE 16 | — | — | — | — | — |
| | TREATED | | | | | | |
| | BINCHO | | | | | | |
| | CHARCOAL | | | | | | |

| DISPERSANT | SODIUM | 9.0 | 9.0 | 9.0 | 9.0 | 9.0 |
|---|---|---|---|---|---|---|
| | LIGNOSULFONATE | | | | | |
| SOLVENT | PROPYLENE | 8.0 | 8.0 | 8.0 | 8.0 | 8.0 |
| | GLYCOL | | | | | |
| | GLYCERIN | 8.0 | 8.0 | 8.0 | 8.0 | 8.0 |
| SURFACTANT | E1010 | 0.1 | 0.1 | 0.1 | 0.1 | 0.1 |
| WATER | PURE WATER | BALANCE | BALANCE | BALANCE | BALANCE | BALANCE |
| TOTAL CONTENT OF TRACE ELEMENT | | 24.0 | 4.8 | 84 | 75 | 9 |
| (ELEMENT A) [MASS ppm] | | | | | | |
| EVALUATION | FOREIGN | AA | AA | A | A | AA |
| | SUBSTANCE | | | | | |
| | RESISTANCE | | | | | |
| | EJECTION | AA | AA | A | A | AA |
| | STABILITY | | | | | |

TABLE 5

| | | | EXAMPLE | \|EXAMPLE | EXAMPLE | EXAMPLE |
|---|---|---|---|---|---|---|
| | | | 6 | 7 | 8 | 9 |
| INK | | | INK 6 | INK 7 | INK 8 | INK 9 |
| COLORANT | CARBIDE | CARBIDE 1 | — | — | — | — |
| | | CARBIDE 2 | — | — | — | — |
| | | CARBIDE 3 | — | — | — | — |
| | | CARBIDE 4 | — | — | — | — |
| | | CARBIDE 7 | — | — | — | — |
| | | CARBIDE 8 | 6.0 | — | — | — |
| | | CARBIDE 9 | — | 6.0 | — | — |
| | | CARBIDE 10 | — | — | 6.0 | — |
| | | CARBIDE 11 | — | — | — | 6.0 |
| | | CARBIDE 12 | — | — | — | — |
| | | CARBIDE 13 | — | — | — | — |
| | | CARBIDE 14 | — | — | — | — |
| | COLORANT | COLORANT 15 | — | — | — | — |
| | OTHER THAN | | | | | |
| | CARBIDE | | | | | |
| | STEAM | CARBIDE 16 | — | — | — | — |
| | TREATED | | | | | |
| | BINCHO | | | | | |
| | CHARCOAL | | | | | |

| DISPERSANT | SODIUM | 9.0 | 9.0 | 9.0 | 9.0 |
|---|---|---|---|---|---|
| SOLVENT | LIGNOSULFONATE | | | | |
| | PROPYLENE GLYCOL | 8.0 | 8.0 | 8.0 | 8.0 |
| | GLYCERIN | 8.0 | 8.0 | 8.0 | 8.0 |
| SURFACTANT | E1010 | 0.1 | 0.1 | 0.1 | 0.1 |
| WATER | PURE WATER | BALANCE | BALANCE | BALANCE | BALANCE |
| TOTAL CONTENT OF TRACE ELEMENT | | 0.6 | 160 | 87 | 204 |
| (ELEMENT A) [MASS ppm] | | | | | |
| EVALUATION | FOREIGN SUBSTANCE | AA | B | A | B |
| | RESISTANCE | | | | |
| | EJECTION STABILITY | AA | B | A | B |

TABLE 6

| | | | COMPAR- | COMPAR- | COMPAR- | COMPAR- | COMPAR- |
|---|---|---|---|---|---|---|---|
| | | | ATIVE | ATIVE | ATIVE | ATIVE | ATIVE |
| | | | EXAM- | EXAM- | EXAM- | EXAM- | EXAM- |
| | | | PLE 1 | PLE 2 | PLE 3 | PLE 4 | PLE 5 |
| INK | | | INK 10 | INK 11 | INK 12 | INK 13 | INK 14 |
| COLORANT | CARBIDE | CARBIDE 1 | — | — | — | — | — |
| | | CARBIDE 2 | — | — | — | — | — |
| | | CARBIDE 3 | — | — | — | — | — |
| | | CARBIDE 4 | — | — | — | — | — |
| | | CARBIDE 7 | — | — | — | — | — |
| | | CARBIDE 8 | — | — | — | — | — |
| | | CARBIDE 9 | — | — | — | — | — |
| | | CARBIDE 10 | — | — | — | — | — |
| | | CARBIDE 11 | — | — | — | — | — |
| | | CARBIDE 12 | 6.0 | — | — | — | — |
| | | CARBIDE 13 | — | 6.0 | — | — | — |
| | | CARBIDE 14 | — | — | 6.0 | — | — |
| | COLORANT OTHER | COLORANT 15 | — | — | — | 4.0 | — |
| | THAN CARBIDE | | | | | | |
| | STEAM TREATED | CARBIDE 16 | — | — | — | — | 6.0 |
| | BINCHO CHARCOAL | | | | | | |

| DISPERSANT | SODIUM LIGNOSULFONATE | 9.0 | 9.0 | 9.0 | 9.0 | 9.0 |
|---|---|---|---|---|---|---|
| SOLVENT | PROPYLENE GLYCOL | 8.0 | 8.0 | 8.0 | 8.0 | 8.0 |
| | GLYCERIN | 8.0 | 8.0 | 8.0 | 8.0 | 8.0 |
| SURFACTANT | E1010 | 0.1 | 0.1 | 0.1 | 0.1 | 0.1 |
| WATER | PURE WATER | BALANCE | BALANCE | BALANCE | BALANCE | BALANCE |
| TOTAL CONTENT OF TRACE ELEMENT | | 200 | 318 | 324 | 0.6 | 4.8 |
| (ELEMENT A) [MASS ppm] | | | | | | |
| EVALUATION | FOREIGN SUBSTANCE | D | C | C | D | D |
| | RESISTANCE | | | | | |
| | EJECTION STABILITY | D | C | C | D | D |

### 5. Evaluation Result

As shown in Tables 1 to 6, according to Examples in each of which the ink composition is an aqueous ink jet ink composition and contains a natural-derived carbide, a dispersant, and a water-soluble organic solvent, and the carbide is a carbide obtained by performing a complex separation treatment and an acid dissolution treatment on an untreated carbide, the evaluations of the foreign substance resistance and the ejection stability are preferable. Hence, the foreign substance resistance and the ejection stability of the ink composition of each Example are excellent.

On the other hand, according to Comparative Examples 1, 2, and 3 in which the carbide 12 is not processed by the complex separation treatment and the acid dissolution treatment, the carbide 13 is not processed by the acid dissolution treatment, and the carbide 14 is not processed by the complex separation treatment, respectively, the foreign substance resistance and the ejection stability are inferior.

In addition, according to Comparative Example 4 in which the pigment 15 containing no carbide is used, the foreign substance resistance and the ejection stability are inferior. The reason for this is believed to be that although the amount of the trace element in the carbide is small, metal ions eluted in the refining step function as a reducing agent and partially decompose chemical bonds of the colorant, and hence, impurities (that is, foreign substances) are generated.

In Comparative Example 5 which uses the carbide 16 obtained by performing, as a refining treatment, a high-temperature steam treatment with a sodium hydroxide without performing the complex separation treatment and the acid dissolution treatment, the foreign substance resistance and the ejection stability are inferior. The reason for this is believed to be that since functional groups, such as OHs, are freshly generated by the steam treatment, adsorption inhibition of the dispersant occurs, and in addition, since the dispersant is depleted due to an increase in specific surface area of the carbide, the dispersibility is degraded, and aggregated foreign substances are generated.

What is claimed is:

1. An aqueous ink jet ink composition comprising:
a natural-derived carbide;
a dispersant; and
a water-soluble organic solvent,
wherein the carbide is a carbide obtained by performing a complex separation treatment and an acid dissolution treatment on an untreated carbide,
the complex separation treatment is a treatment to remove a complex obtained by mixing the untreated carbide and a chelating agent, and
the acid dissolution treatment is a treatment to remove a water-soluble salt obtained by mixing the untreated carbide and an acid.

2. The ink jet ink composition according to claim 1,
wherein the carbide is a carbide processed by the complex separation treatment and the acid dissolution treatment in this order.

3. The ink jet ink composition according to claim 1,
wherein in the complex separation treatment, the untreated carbide and the chelating agent are mixed in an aqueous solution, and
the chelating agent includes an aminocarboxylic acid-based chelating agent.

4. The ink jet ink composition according to claim 1,
wherein in the acid dissolution treatment, the untreated carbide and the acid are mixed in an aqueous solution, and
the acid includes a nitric acid.

5. The ink jet ink composition according to claim 1,
wherein the carbide includes a vegetable-derived carbide.

6. The ink jet ink composition according to claim 1,
wherein the untreated carbide has a volume average particle diameter D50 of 0.5 to 100 μm.

7. The ink jet ink composition according to claim 1,
wherein the ink jet ink composition contains an element A selected from the group consisting of P, S, Si, Cl, Mg, Al, K, Na, Ca, Cr, Ti, Mn, Fe, Ni, and Cu, and
a content of the element A with respect to a total mass of the carbide is 10 to 5,000 mass ppm.

8. The ink jet ink composition according to claim 1,
wherein the dispersant includes a lignin compound.

9. A method for manufacturing a carbide which is used for the ink jet ink composition according to claim 1, the method comprising:
performing a complex separation treatment and an acid dissolution treatment on an untreated carbide,
wherein the complex separation treatment is a treatment to remove a complex obtained by mixing the untreated carbide and a chelating agent, and
the acid dissolution treatment is a treatment to remove a water-soluble salt obtained by mixing the untreated carbide and an acid.

10. A recording method comprising:
ejecting the ink jet ink composition according to claim 1 from an ink jet head so as to be adhered to a recording medium.
